(19) United States
(12) Patent Application Publication
(10) Pub. No.: US 2017/0277488 A1
(43) Pub. Date: Sep. 28, 2017

(54) CONTROL DEVICE, IMAGE PROCESSING APPARATUS, NON-TRANSITORY COMPUTER READABLE MEDIUM STORING PROGRAM, INFORMATION PROCESSING CONTROL SYSTEM, AND IMAGE PROCESSING METHOD

(71) Applicant: FUJI XEROX CO., LTD., Tokyo (JP)

(72) Inventor: Keisuke Komatsubara, Kanagawa (JP)

(21) Appl. No.: 15/208,747

(22) Filed: Jul. 13, 2016

(30) Foreign Application Priority Data
Mar. 23, 2016 (JP) 2016-058447

(51) Int. Cl. G06F 3/12; H04N 1/00

(52) U.S. Cl. CPC G06F 3/1238; H04N 1/00037; G06F 3/1222; G06F 3/1236; G06F 3/1292; H04N 2201/006

(57) ABSTRACT

A control device includes: a wireless communication section that operates while being continuously supplied with power; and a detection section that detects approach of a user. The control device further includes: an authentication processing section that authenticates a user of a terminal in response to reception of a request from the terminal by the wireless communication section when supply of power to a processing section of an information processing apparatus is stopped; and a control section that starts supplying power to the processing section when the approach of the user of the terminal is detected by the detection section after the authentication succeeds.

### CROSS-REFERENCE TO RELATED APPLICATIONS

This application is based on and claims priority under 35 USC 119 from Japanese Patent Application No. 2016-058447 filed on Mar. 23, 2016.

### BACKGROUND

1. Technical Field

The present invention relates to a technique using an information processing apparatus by using a portable terminal.

2. Related Art

There has been provided a system that allows a user to access an information processing apparatus by using a portable wireless communication terminal.

### SUMMARY

According to an aspect of the invention, there is provided a control device including: a wireless communication section that operates while being continuously supplied with power; a detection section that detects approach of a user; an authentication processing section that authenticates a user of a terminal in response to reception of a request from the terminal by the wireless communication section when supply of power to a processing section of an information processing apparatus is stopped; and a control section that starts supplying power to the processing section when the approach of the user of the terminal is detected by the detection section after the authentication succeeds.

### BRIEF DESCRIPTION OF THE DRAWINGS

Exemplary embodiments of the present invention will be described in detail based on the following figures, wherein:

FIG. 1 is a diagram showing an outline of an information processing system;

FIG. 2 is a diagram showing a functional configuration of an image forming apparatus;

FIG. 3 is a diagram showing a functional configuration of an authentication server;

FIG. 4 is a diagram showing a functional configuration of a portable terminal;

FIG. 5 is a diagram showing the operation of the information processing system;

FIG. 6 is a diagram showing an operational example during transition to a low power consumption mode; and

FIG. 7 is a diagram showing an example of an image displayed on a screen of the portable terminal.

### DETAILED DESCRIPTION

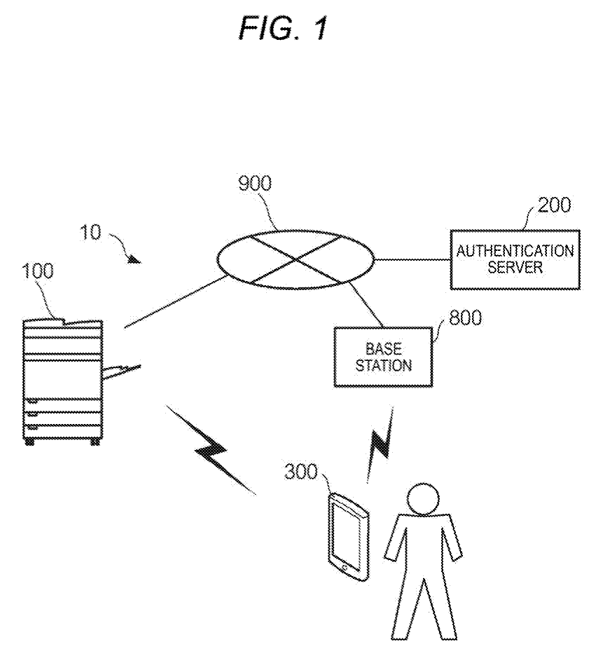

FIG. 1 shows an outline of an information processing system 10. The information processing system 10 includes an image forming apparatus 100, an authentication server 200, a portable terminal 300, and a network 900. Meanwhile, only one image forming apparatus 100 is shown in the drawing, but plural image forming apparatuses may be present.

The portable terminal 300, which is a wireless communication terminal device carried by a user, is a general information electronic device such as a tablet computer or a smart phone. The image forming apparatus 100 is an image forming apparatus, such as a printer, a scanner, a facsimile, and an e-mail, which have functions related to image formation or the transmission and reception of image data. The authentication server 200 is an authentication server having a database that stores information on a user who is permitted to use the image forming apparatus 100. The image forming apparatus 100 and the authentication server 200 are connected to each other through the network 900. The network 900 is, for example, the Internet or an intracompany LAN. The portable terminal 300 and the authentication server 200 are connected to each other through a base station 800 and the network 900.

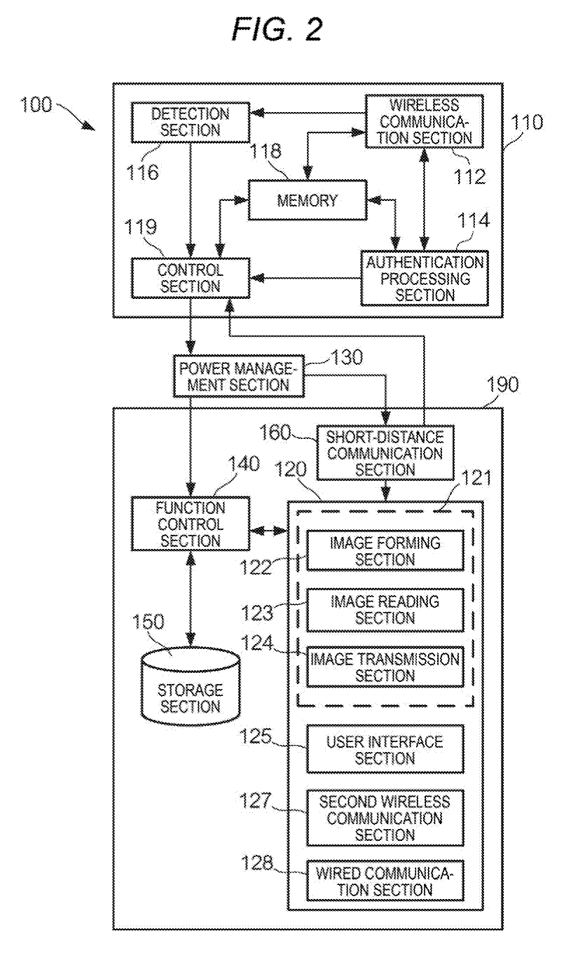

FIG. 2 shows a functional configuration of the image forming apparatus 100. The image forming apparatus 100 includes a communication unit 110, a power management section 130, and an information processing unit 190. The communication unit 110 functions as a control device that communicates with the portable terminal 300 to perform user authentication and controls the supply of power to the information processing unit 190 on the basis of an authentication result. The information processing unit 190 is an assembly of functions related to image formation which operates while being supplied with predetermined power. The power management section 130 controls the supply of power (start or termination) to the information processing unit 190.

During the operation of the image forming apparatus 100, power is supplied to the communication unit 110 and the power management section 130 at all times from a power supply not shown in the drawing, and thus the communication unit 110 and the power management section 130 continuously operate. On the other hand, power is supplied to the information processing unit 190 as necessary. In other words, a function of the communication unit 110 is maintained at all times, but at least a portion of the information processing unit 190 is not limited to functioning at all times. This is for the purpose of suppressing power consumption in the image forming apparatus 100 by stopping at least a portion of the functions of the information processing unit 190 in a case where it is not necessary to execute processing. Hereinafter, a state where power is supplied to only the communication unit 110 and the power management section 130 (a state where the image forming apparatus 100 operates with first power) is referred to as a low power consumption mode, and a state where, in addition to the communication unit 110 and the power management section 130, at least a portion of the information processing unit 190 functions (a state where the image forming apparatus 100 operates with second power greater than the first power) is referred to as a high power consumption mode.

The communication unit 110 includes a wireless communication section 112, an authentication processing section 114, a detection section 116, a memory 118, and a control section 119. The communication unit 110 is implemented as a wireless transmission and reception unit according to, for example, Bluetooth (registered trademark) Low Energy (BLE) standard or the like.

The wireless communication section 112 is a transmission and reception module including an antenna and a signal processing circuit. The wireless communication section 112 communicates with the portable terminal to transmit and receive, in addition to information required to perform wireless communication with the portable terminal 300, information such as a user ID or a password which is used to perform user identification, information for designating one or more functions (printing, scanning, the transmission of an e-mail, and the like) which are desired to be used by a user among plural functions of the image forming apparatus 100, and information regarding the approach of the portable terminal 300. Specifically, the wireless communication section 112 periodically broadcasts a beacon including identification information of the communication unit 110, and receives a wireless signal transmitted from the portable terminal 300 having responded to the beacon. Information necessary for authentication and information regarding function designation of the image forming apparatus 100 are output to the authentication processing section 114. On the other hand, a signal regarding the approach of the portable terminal 300 is output to the detection section 116.

The memory 118, which is a memory module such as a nonvolatile memory, stores not only information required to perform wireless communication with the portable terminal 300 but also information required to use the image forming apparatus 100 by a user of the portable terminal 300 and information received from the portable terminal 300.

The authentication processing section 114, which is implemented as a processor, transmits information (an address used for the portable terminal 300 to approach the authentication server 200, and the like) which is required to perform an authentication process through the wireless communication section 112 to the portable terminal 300, and outputs authentication information received from the portable terminal 300 to the control section 119.

The detection section 116, which is implemented as a processor, calculates a distance from the portable terminal 300 on the basis of signal intensity received, and determined that a user of the portable terminal 300 has approached the image forming apparatus 100 when the signal intensity falls below a threshold value. In addition, even when a predetermined command transmitted in relation to the degree of approach from the portable terminal 300 is received, it is determined that the user of the portable terminal 300 has approached the image forming apparatus 100. A determination result is output to the control section 119.

The control section 119, which is implemented as a processor, starts supplying power to the information processing unit 190 when the approach of a user of the terminal is detected by the detection section after the authentication has succeeded. Specifically, a control signal for commanding the start of power supply is output to the power management section 130 so that at least a portion of functions of the information processing unit 190 are validated. In addition, in a case where the authentication information received from the portable terminal 300 includes functional information indicating any one or more functions desired to be used by a user among plural functions of the information processing unit 190, a signal for designating which one or more functions of the plural functions of the information processing unit 190 are to be validated is also output to the power management section 130. Thereby, in a case where a request received from the portable terminal 300 includes information for designating one or more functions, power is supplied to only a module corresponding to the designated one or more functions.

In addition, the control section 119 includes a timer, and measures an elapsed time since the completion of authentication. Meanwhile, the authentication processing section 114, the detection section 116, and the control section 119 may be implemented as one processor, or may be implemented as individual processor modules.

The power management section 130, which is a processor for controlling a power supply, performs the supply of power to each section (a function control section 140 is also included) of the information processing unit 190 by receiving a control signal from the control section 119 to make the each section transition to a high power consumption mode. At this time, the power management section 130 can independently select whether to supply power to each section of the information processing unit 190 (in other words, whether to validate or invalidate each functional module). For example, in a case where a function supplied form the control section 119 is a function for designating printing, power is supplied to only the function control section 140, an image forming section 122, and a user interface section 125 which are necessary for a printing function. However, in a case where an operation such as the input or confirmation of printing conditions is not necessary, power may be supplied to only the function control section 140 and the image forming section 122. On the other hand, in a case where copying is designated, power is supplied to an image processing unit 121, the image forming section 122, an image reading section 123, and the user interface section 125.

In addition, the power management section 130 controls the stop of power supply to the information processing unit 190 on the basis of a control signal from the function control section 140. Specifically, in a high power consumption mode, the function control section 140 monitors an operational state of each section of the information processing unit 190. In a case where a predetermined condition (for example, a condition in which an input through the user interface section 125 is not performed for a predetermined period of time, a condition in which an input through a short-distance communication section 160, a second wireless communication section 127, and a wired communication section 128 is not performed, or the like) is satisfied, a control signal is output to the power management section 130, and the power management section 130 stops the supply of power to each section of the information processing unit 190 to thereby make the information processing unit 190 transition to a low power consumption mode. For example, in a case where an input to the user interface section 125 is not performed for a predetermined period of time, the supply of power to the user interface section 125 and the image processing unit 121 is stopped.

The information processing unit 190 includes a functional unit 120, a function control section 140, a storage section 150, and the short-distance communication section 160.

The functional unit 120, which is a functional module group for implementing functions of the image forming apparatus 100, includes the image processing unit 121, the user interface section 125, the second wireless communication section 127, and the wired communication section 128.

The image processing unit 121, which is a functional module related to image formation and the transmission and reception of image data, includes the image forming section 122, the image reading section 123, and an image transmission section 124. The image forming section 122, which is implemented as hardware such as an image processor, a developing device, a developer (toner), a charging device, a light source, an optical system, a recording medium (paper), a photosensitive drum, or a paper transport mechanism, is a functional unit for forming an image on a recording medium on the basis of image data by an electrophotographic method.

The image reading section 123, which is implemented as an image sensor or an image processor, is a functional unit for generating image data by optically reading an image formed on a medium.

The image transmission section 124, which is implemented as a communication interface or a signal processor, is a functional unit for transmitting and receiving image data read by the image reading section 123 or image data generated by the image forming section 122 to and from another device through a network, transmitting the image data as facsimile data through a telephone line, and transmitting and receiving the image data as e-mail data.

The user interface section 125 is a functional unit for displaying information regarding processing such as image formation or the transmission and reception of image data and for receiving an instruction related to image formation or the transmission and reception of an image from a user, and is implemented as, for example, a touch panel.

The second wireless communication section 127, which is implemented as an antenna or a signal processing circuit, transmits and receives information to and from the portable terminal 300 in accordance with a wireless communication standard such as WiFi (registered trademark), WiFi-Direct, or Bluetooth (registered trademark). Specifically, the second wireless communication section transmits setting information necessary for image formation to the portable terminal 300, and receives information (image data which is a target for image formation, a parameter which is used for image formation, or the like) for designating contents of image processing from the portable terminal 300. However, the transmission and reception of information regarding authentication to and from the portable terminal 300 are performed through only the wireless communication section 112.

The wired communication section 128, which is a wired LAN interface, transmits and receives information to and from the authentication server 200. Specifically, the wired communication section has access to the authentication server 200 to request a user's authentication, and receives an authentication result.

The short-distance communication section 160, which is implemented as a short-distance wireless communication module based on a standard such as near field communication (NFC), transmits or receives information to or from the portable terminal 300. Specifically, a user brings the portable terminal 300 into close to a short-distance wireless communication module built in the image forming apparatus 100, for example, up to a distance equal to or less than several centimeters to thereby input information, such as a predetermined command or data to be processed, to the image forming apparatus 100. A signal indicating that an input of information is performed through the short-distance communication section 160 is output to the control section 119.

The storage section 150, which is a storage device such as a semiconductor memory or a hard disk, stores user identification information and terminal identification information that are supplied from the communication unit 110 in association with each other, in addition to a control program for implementing the operation (details will be described later) of the image forming apparatus 100. In addition, information to be subjected to processing (image data to be printed, or the like) regarding the user's instruction, which is executed in the image processing unit 121, may be stored in association with user identification information and terminal identification information. Meanwhile, authentication information is deleted when a predetermined condition (a case where processing is completed or a case where a predetermined period of time elapses from the generation of authentication information) is satisfied. Thereby, the number of portable terminals 300 that permit the use of the image forming apparatus 100 is appropriately maintained.

The function control section 140, which is a processor such as a CPU, controls all of the operations of the information processing unit 190 other than the control of power. Meanwhile, the function control section 140 may operate a portion of the operations in accordance with functional information supplied from the control section 119. For example, the function control section 140, which is implemented as plural modules taking charge of the control of the sections of the functional unit 120, operates only a portion taking charge of the control of a function corresponding to the image processing unit 121 and stops the other portions. In short, a designated function may be implemented in the image forming apparatus 100, and minimum power required may be supplied to the information processing unit 190 at that time.

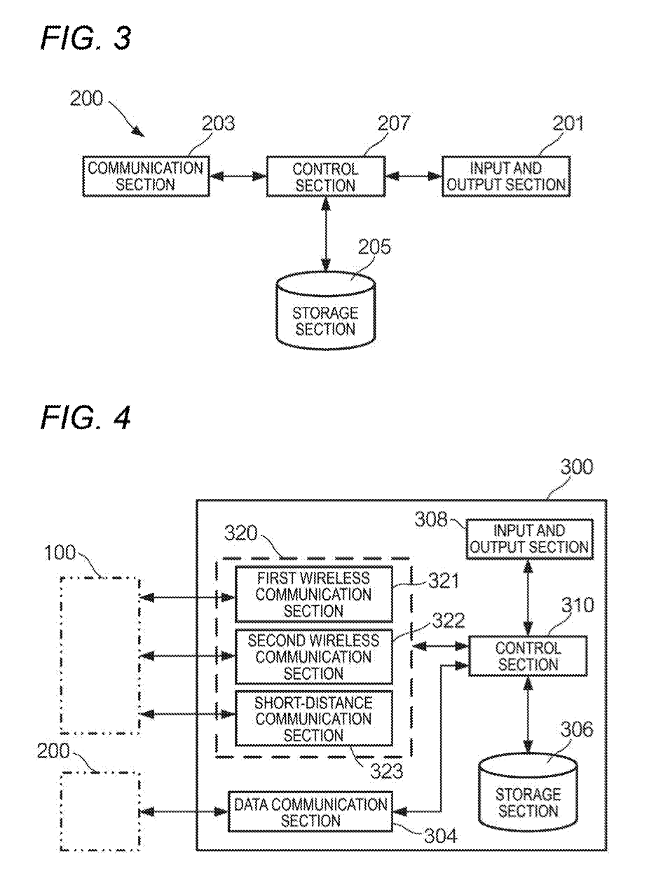

FIG. 3 shows a functional configuration of the authentication server 200. The authentication server 200 includes a communication section 203, an input and output section 201, a storage section 205, and a control section 207.

The storage section 205, which is a hard disk or a semiconductor memory, stores a database in which an identifier for specifying a user and information regarding permission or non-permission of use of the image forming apparatus 100 by the user are registered. Meanwhile, the database may further store information regarding usage contents (a usable specific function among the functions of the image forming apparatus 100) in addition to information indicating the permission or non-permission of use. Information regarding a use condition (validated date or the like) of the image forming apparatus 100 may be further stored in the database.

The input and output section 201, such as a keyboard or a display, is used when a manager of the authentication server 200 inputs and outputs information. The communication section 203, which is a LAN interface, transmits authentication information with reference to a database when receiving a request for user authentication from the authentication server 200 or the portable terminal 300 through the base station 800.

FIG. 4 shows a functional configuration of the portable terminal 300. The portable terminal 300 includes a wireless communication unit 320, a data communication section 304, an input and output section 308, a storage section 306, and a control section 310. The wireless communication unit 320 includes a first wireless communication section 321, a second wireless communication section 322, and a short-distance communication section 323.

The first wireless communication section 321 is implemented as a module that performs wireless communication with the wireless communication section 112 in accordance with a standard such as Bluetooth (registered trademark) Low Energy. Specifically, the first wireless communication section receives a beacon transmitted from the communication unit 110 and transmits information necessary for authentication (may include at least a user ID in addition to a password). In addition to the information necessary for authentication, information for designating a function of the image forming apparatus 100 may be included. In addition, the first wireless communication section 321 may calculate information indicating the degree of approach between the image forming apparatus 100 and the portable terminal 300, and may transmit a command for commanding the image forming apparatus 100 to validate a function on the basis of the information to the wireless communication section 112. For example, the first wireless communication section 321 calculates a distance to the image forming apparatus 100 on the basis of signal intensity (RSSI) received from the image forming apparatus 100, and transmits a signal indicating that the distance is set to be equal to or less than a threshold value.

The second wireless communication section 322 transmits and receives information to and from the second wireless communication section 127 in accordance with a wireless communication standard such as WiFi (registered trademark), WiFi-Direct, or Bluetooth (registered trademark) Classic. The short-distance communication section 323, which is implemented as a short-distance wireless communication module based on a standard such as near field communication (NFC), transmits and receives information to and from the short-distance communication section 160. The data communication section 304 is a communication module for transmitting and receiving information to and from the authentication server 200 through the network 900 in accordance with a wireless communication standard such as 3G or LTE. The input and output section 308, which is a touch panel or the like, is used to input information necessary for authentication or a function that a user desires to use, among functions of the image forming apparatus 100.

The control section 310, which is a processor, controls the wireless communication unit 320, the data communication section 304, the input and output section 308, and the storage section 306. The storage section 306, which is a nonvolatile semiconductor memory, stores an application program for causing the image forming apparatus 100 to implement an operation to be described later in order to use the image forming apparatus 100 using the portable terminal 300, in addition to an OS. In addition, data such as image data which is used for processing using the image forming apparatus 100 is stored. Meanwhile, the information necessary for authentication may be stored in the input and output section 308 in advance and may be read out every time the image forming apparatus 100 is accessed, instead of being input from the storage section 306 every time the image forming apparatus 100 is accessed.

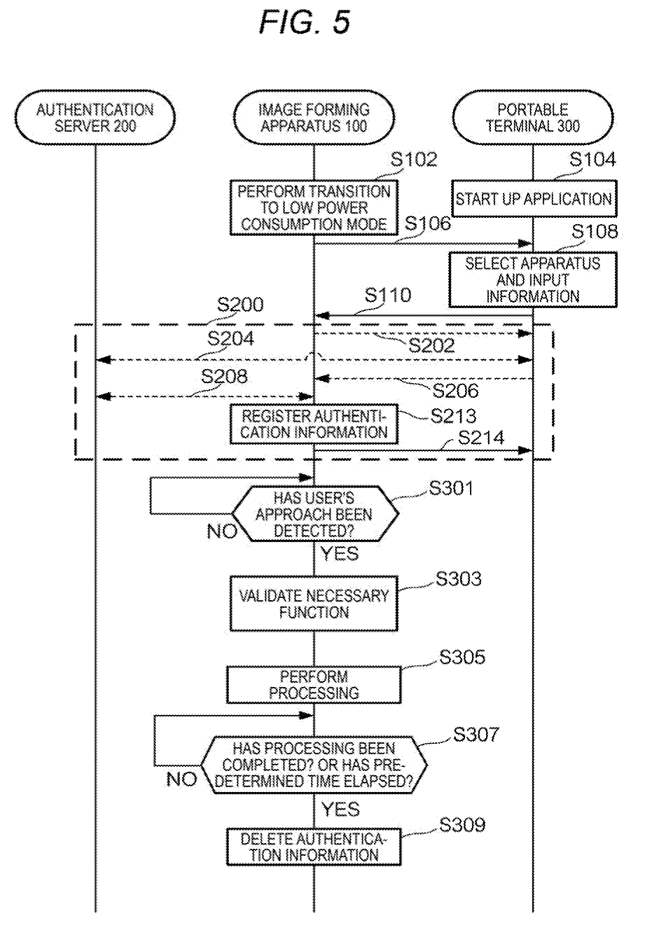

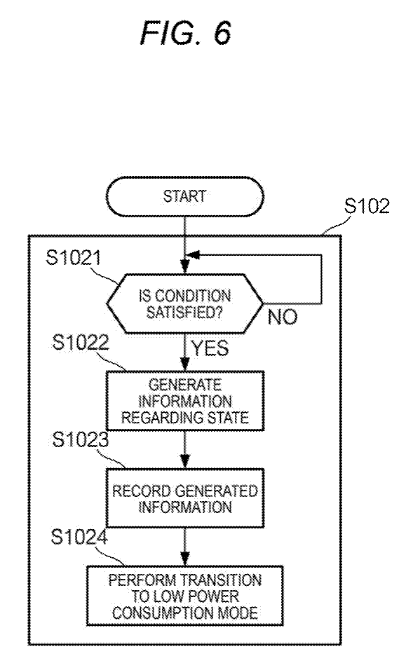

FIG. 5 shows the operation of the information processing system 10. A user operates the portable terminal 300 in advance to start up an application program (S104). Now, it is assumed that the image forming apparatus 100 is in a low power consumption mode (S102). Here, a process associated with switching to a low power consumption mode will be described with reference to FIG. 6.

In the high power consumption mode, the power management section 130 always monitors whether a predetermined condition is satisfied (S1021). When it is determined that the condition is satisfied (S1021, YES), the power management section generates state information regarding the state of the image forming apparatus 100 at that point in time before performing transition to the low power consumption mode (S1022). Specifically, the state information includes information for designating information necessary for authentication and information regarding a usable function. The information necessary for authentication refers to information necessary for authentication which is assumed to be input by a user in this case, and is information for designating, for example, a user ID and a password. Alternatively, the information may include information for having access to a predetermined authentication server in addition to the user ID and the password in a case where it is not desired that the wired communication section 128 is made to function.

The information regarding a usable function is information for designating a function of the image forming apparatus 100 which is permitted to be used by a user when return from a low power consumption mode occurs later. For example, when image data provided from a user is not stored (spooled) in the storage section 150 at that point in time, the function control section 140 generates information for designating “copying”, “scanning”, “facsimile”, and “box transmission”. On the other hand, when the image data is stored, information for designating “printing” is generated in addition to “copying”, “scanning”, “facsimile”, and “box transmission”.

In this manner, a process that can be used by a user may vary depending on the presence or absence or type of data held in the image forming apparatus 100. In addition, the function control section 140 may check whether or not each functional module normally operates, may read out setting information, or may generate information for designating functions other than a function implemented using the functional module during a breakdown or in a case where there is a functional module which is set to deny the use of a user of the portable terminal 300.

The generated information is stored in the memory 118 through the control section 119 (S1023). Thereafter, the power management section 130 performs transition to a low power consumption mode (S1024).

Referring back to FIG. 5, when transition to a low power consumption mode is performed, a beacon is intermittently transmitted from the communication unit 110 (S106). After the beacon transmitted from the image forming apparatus 100 is received by the portable terminal 300 in which an application program is being executed, communication according to a predetermined standard such as Bluetooth LE is performed between the communication unit 110 and the portable terminal 300 in this exemplary embodiment, and thus state information stored in the memory 118 of the communication unit 110 is received by the portable terminal 300, thereby displaying the information necessary for authentication and the usable function on the screen of the portable terminal 300 together with information for identifying the image forming apparatus 100. The communication performed between the communication unit 110 and the portable terminal 300 at this time is performed only with power supplied to the communication unit 110, and does not have an influence on a low power consumption mode of the image forming apparatus 100. In addition, a description has been given of an example in which the communication of the beacon and the communication of the state information are performed independently of each other, but state information may be included in a beacon itself so that the beacon and the state information are simultaneously received.

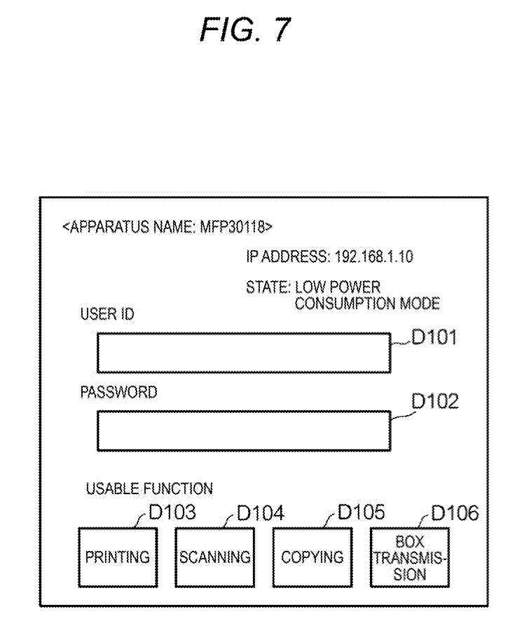

An example of information displayed on the screen of the portable terminal 300 is shown in FIG. 7. In the drawing, information necessary for authentication includes a user ID and a password, and input fields D101 and D102 are provided therefor. In addition, objects D103, D104, D105, and D106 corresponding to functions (printing, scanning, copying, and box transmission) which can be used in the image forming apparatus 100 are displayed, and a user can select one or more among the functions.

Meanwhile, in a case where the portable terminal 300 receives beacons from the plural image forming apparatuses 100, a list of the plural image forming apparatuses 100 is displayed on the input and output section 308, and a user is prompted to select a device with which communication is performed.

Referring back to FIG. 5, the user selects one image forming apparatus 100 to be used with reference to functions displayed or the like, and inputs information necessary for authentication (S108). In addition, the user designates at least one function desired to be used, among the displayed functions.

The information which is input is transmitted to the image forming apparatus 100 (one selected image forming apparatus 100 in a case where plural apparatuses are detected) together with apparatus identification information of the portable terminal 300 (S110). When the communication unit 110 receives an apparatus identifier of the portable terminal 300 and a user identifier, the communication unit stores the identifiers in association with each other. Hereinafter, when the image forming apparatus 100 and the portable terminal 300 communicate with each other, a communication party is specified by including the apparatus identifier in a transmission signal.

Subsequently, the communication unit 110 authenticates a user of the portable terminal 300 (S200). Specifically, any one of the following methods is used.

A first method is a method in which the portable terminal 300 has access to the authentication server 200. Specifically, information (the URL of the authentication server 200, or the like) for having access to the authentication server 200 from the wireless communication section 112 is transmitted to the portable terminal 300 (S202). The portable terminal 300 having received the URL or the like transmits a request for authentication including information necessary for authentication, such as a user identifier and a password, to the authentication server 200 (S204). When the portable terminal 300 acquires an authentication result from the authentication server 200, the portable terminal transmits the acquired authentication result to the communication unit 110 through the first wireless communication section 321 (S206).

A second method is a method in which the image forming apparatus 100 has access to the authentication server 200. Specifically, the power management section 130 supplies power to the function control section 140 and the wired communication section 128 to validate the function of the wired communication section 128, and then transmits a request for authentication to the authentication server 200 from the image forming apparatus 100 through the wired communication section 128 using information necessary for authentication which is transmitted from the memory 118 to the storage section 150, to thereby acquire an authentication result from the authentication server 200 (S208). At this time, the power management section 130 stops a functional module which is not related to the wired communication section 128. This method results in an increase in power consumption as compared to the first method, but is useful in a case where access to the authentication server 200 from the portable terminal 300 is not permitted or a case where the portable terminal 300 allows only access through a wired LAN.

Which of the first and second methods is used may be determined in advance by the image forming apparatus 100, or may be determined by the image forming apparatus 100 on the basis of an operational state of the wired communication section 128. Meanwhile, the first and second methods may be combined with each other. For example, first, the portable terminal 300 may be made to perform authentication using the first method. In a case where the authentication fails for some reason, the portable terminal 300 may notify the image forming apparatus 100 of the failure of the authentication, and the image forming apparatus 100 may perform the second method when receiving the notification.

In a case where an authentication result acquired from the authentication server 200 indicates that the user is permitted to use the image forming apparatus 100 (in other words, in a case where authentication succeeds), the control section 119 generates authentication information (use ticket) and stores user identification information, apparatus identification information of the portable terminal 300, and a point of time at which authentication information is generated, in the memory 118 in association with each other (S213). Subsequently, the communication unit 110 transmits the authentication result to the portable terminal 300 through the wireless communication section 112 (S214). In the portable terminal 300, the authentication result is displayed.

In a case a failure in authentication such as a case where the authentication result acquired from the authentication server 200 is that the user is not permitted to use the image forming apparatus 100, a screen for prompting the user to input authentication information again is displayed. The information which is input again is transmitted to the wireless communication section 112 from the first wireless communication section 321, and steps S202 to S214 are repeated.

When the authentication succeeds, the image forming apparatus 100 starts a clocking process and monitors the approach of the portable terminal 300 (S301). Specifically, any one or more of the following three methods are used.

A first method is a method in which the image forming apparatus 100 independently detects approach. That is, the detection section 116 determines the presence or absence of a user's approach on the basis of the intensity of a radio wave received from the portable terminal 300 by the wireless communication section 112. Specifically, when the intensity of the radio wave which is calculated by the detection section 116 is set to be equal to or less than a threshold value, the communication unit 110 determines that a distance from the portable terminal 300 is set to be a preset distance (for example, 1 m). The preset distance may be determined by estimating a period of time from the supply of power to a state where processing can be actually performed through a preparation operation (preheating or the like) of the image processing unit 121 and by estimating a timing when a user starts performing input to the image forming apparatus 100.

A second method is a method of making the portable terminal 300 to determine a distance. That is, in a case where the detection section 116 receives a predetermined command from the terminal by the wireless communication section 112, the detection section determines a user's approach. Specifically, an application program operating in the portable terminal 300 may include a code so as to transmit a predetermined command from the first wireless communication section 321 to the wireless communication section 112 when the intensity of the radio wave which is received from the image forming apparatus 100 is set to be equal to or less than a predetermined value. In a case where the detection section 116 receives a predetermined signal (command) from the portable terminal 300, it is determined that the detection section 116 has approached the portable terminal 300. According to this method, a predetermined distance (the degree of approach) can be set by a user. Accordingly, a command can be transmitted to the wireless communication section 112 at a timing when the user desires to input an instruction to the image forming apparatus 100 (for example, one second before reaching the image forming apparatus 100, or the like) to thereby prepare the start-up of the functional unit 120. Even in both the first and second methods, only the communication unit 110 operates, and thus a low power consumption mode is maintained.

In a third method, the power management section 130 supplies power to the short-distance communication section 160 when authentication is completed, and determines a user's approach when receiving a predetermined command from the portable terminal 300 through the short-distance communication section 160. Although power is excessively consumed in the image forming apparatus 100 by the amount of functioning of the short-distance communication section 160, the image processing unit 121 consuming a relatively large amount of power is still stopped, and thus power consumption related to authentication using this method does not much matter. In this case, it is possible to reliably determine that a user can input an instruction for processing through the user interface section 125 right nearby (for example, 10 cm) the image forming apparatus 100 due to a communication range of the short-distance communication section 160. The short-distance communication section 160 outputs a signal indicating the user's approach to the control section 119.

When the control section 119 detects the approach of the portable terminal 300 using any of the above-mentioned methods (S301: YES), the control section outputs a control signal to the power management section 130. The power management section 130 validates a necessary function among the functions of the information processing unit 190 (S303). Specifically, in a case where functional information acquired from the terminal of which the approach is detected is registered with reference to the memory 118, the power management section 130 validates only a functional module corresponding to the function. Since power is not supplied to a function which is not used by a user, power is not excessively consumed. On the other hand, in a case where functional information is not registered, all of the functions of the information processing unit 190 are validated. In this case, even when any instruction is given from a user, the image forming apparatus 100 can perform a process based on the input instruction. In addition, the power management section 130 supplies power to at least a portion of the function control section 140 and transmits information stored in the memory 118 to the storage section 150.

Meanwhile, even when functional information is not registered in the memory 118, the function control section 140 checks whether or not user identification information or terminal identification information and information for designating processing contents or information to be processed (image data or the like) are stored in the storage section 150 in association with each other with reference to the storage section 150 before S102. In a case where the pieces of information are stored in the storage section, the function control section may specify information for designating processing contents or processing related to an object to be processed, and may specify a functional module within the information processing unit 190 which corresponds to the specified processing. For example, in a case where image data is stored in advance in association with user identification information, the processing based on the image data is determined to be processing (printing) of forming the image data on paper.

Thereafter, the image forming apparatus 100 receives an instruction for processing from a user and performs the processing (S305). This instruction includes processing contents (type) and the designation of data to be processed. For example, in a case where the processing is printing, a user inputs printing conditions such as the number of prints and image quality through the user interface section 125, and designates an image to be processed. For example, a location where image data, which is transmitted through the second wireless communication section 127 or is located on a network, is input by the user interface section 125. In addition, processing is performed using a validated functional module. As a result, for example, in a case of printing, paper having the image formed thereon on the basis of the image data is discharged from the image forming apparatus 100. Meanwhile, in a case where data to be processed is specified in S303, printing may be performed using predetermined printing conditions without waiting for the input of printing conditions.

The function control section 140 determines whether the processing has been completed and whether a predetermined period of time has elapsed since the generation of authentication information (S307). In a case where the processing has not been completed for the reason such as a case where the processing has been completed or a case where there is no instruction given from a user, but a predetermined period of time has elapsed since the generation of authentication information (S307: YES), the authentication information regarding the user is deleted from the storage section 150 (S309).

According to the above-described exemplary embodiment, even when the authentication of a user attempting to use the image forming apparatus 100 fails, a low power consumption state is maintained in the image forming apparatus 100. Even when an authentication process is performed again, power is not excessively consumed.

In addition, even when authentication succeeds, a low power consumption state is maintained until a user approaches the image forming apparatus 100, without immediately returning the image forming apparatus 100 to a normal power consumption state. That is, a low power consumption state is maintained in a case where there is a strong possibility of the user not inputting an instruction for the execution of processing, in a case of a step in which a corresponding time is required until an input is performed, and in a state where the image forming apparatus 100 cannot substantially receive an instruction from the user. In addition, since previous authentication has been completed in response to input of an instruction to the image forming apparatus 100, the user may not wait until the authentication process is completed.

The invention is not limited to being applied to an image forming apparatus, and may be applied to a general information processing apparatus which is not related to the processing of image data insofar as the information processing apparatus includes the communication unit 110. For example, all or a portion of the image processing unit 121 may be omitted.

In short, a control device related to the invention includes a wireless communication section that operates while being continuously supplied with power, a detection section that detects a user's approach, an authentication processing section that authenticates a user of a terminal in response to reception of a request from the terminal by the wireless communication section when the supply of power to a processing section of an information processing apparatus is stopped, and a control section that starts supplying power to the processing section when the approach of the user of the terminal is detected by the detection section after the authentication succeeds.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A control device comprising:
a wireless communication section that operates while being continuously supplied with power;
a detection section that detects approach of a user;
an authentication processing section that authenticates a user of a terminal in response to reception of a request from the terminal based on an input by the user of the terminal by the wireless communication section when supply of power to a processing suction of an Information processing apparatus is stopped; and
a control section that starts supplying power to the processing section when the approach of the user of the terminal is detected by the detection section after the authentication succeeds.

2. The control device according to claim 1,
wherein the authentication processing section transmits information for accessing an authentication server to the terminal through the wireless communication section, and receives authentication information indicating that the user has been authenticated and generated by the authentication server from the terminal through the wireless communication section.

3. The control device according to claim 1,
wherein in a case where the authentication fails, the authentication processing section notifies the terminal of the failure of the authentication through the wireless communication section, and prompts the terminal to input authentication information again.

4. The control device according to claim 2,
wherein in a case where the authentication fails, the authentication processing section notifies the terminal of the failure of the authentication through the wireless communication section, and prompts the terminal to input authentication information again.

5. The control device according to claim 1,
wherein the detection section determines the approach of the user on the basis of intensity of a radio wave received from the terminal by the wireless communication section.

6. The control device according to claim 2,
wherein the detection section determines the approach of the user on the basis of intensity of a radio wave received from the terminal by the wireless communication section.

7. The control device according to claim 3,
wherein the detection section determines the approach of the user on the basis of intensity of a radio wave received from the terminal by the wireless communication section.

8. The control device according to claim 4,
wherein the detection section determines the approach of the user on the basis of intensity of a radio wave received from the terminal by the wireless communication section.

9. The control device according to claim 1,
wherein the detection section determines the approach of the user in a case where a predetermined command is received from the terminal by the wireless communication section.

10. The control device according to claim 2,
wherein the detection section determines the approach of the user in a case where a predetermined command is received from the terminal by the wireless communication section.

11. The control device according to claim 3,
wherein the detection section determines the approach of the user in a case where a predetermined command is received from the terminal by the wireless communication section.

12. The control device according to claim 1, further comprising:
a storage section that operates while being continuously supplied with power and stores state information regarding a state of the processing section before supply of power to the processing section is stopped,
wherein the state information is transmitted to the terminal through the wireless communication section.

13. The control device according to claim 1,
wherein the processing section comprises a plurality of modules implementing a plurality of functions each of which is related to image formation or transmission and reception of image data,
wherein the request comprises information for designating one or more functions, and
wherein the control section supplies power to modules corresponding to the one or more designated functions.

14. The control device according to claim 1, further comprising:
a storage section that stores mage data to be processed in association with the terminal,
wherein the processing section comprises a plurality of modules implementing a plurality of functions each of which is related to image formation or transmission and reception of image data, and
wherein in response to detection of the approach, the control section supplies power to one of the plurality of modules, which performs processing based on the image data stored in the storage section.

15. The control device according to claim 1, further comprising:
a storage section,
wherein authentication information indicating that the user has been authenticated is deleted when processing in the processing section is completed.

16. The control device according to claim 1, further comprising:
a storage section,
wherein authentication information indicating that the user has been authenticated is deleted when a predetermined time elapses after the authentication succeeds.

17. An image processing apparatus comprising:
a wireless communication section that operates while being continuously supplied with power;
a processing section that performs processing related to image formation or transmission and reception of image data;
a detection section that detects approach of a user;
an authentication processing section that authenticates a user of a terminal in response to reception of a request from the terminal based on an input by the user of the terminal by the wireless communication section when supply of power to the processing section is stopped; and
a control section that starts supplying power to the processing section when the approach of the user of the terminal is detected by the detection section after the authentication succeeds.

18. A non-transitory computer readable medium storing a program causing a computer of an information processing apparatus. the information processing apparatus comprising a wireless communication section that operates while being continuously supplied with power, a processing section, and a detection section that detects approach of a user, to execute a process comprising:
authenticating a user of a terminal in response to reception of a request from the terminal based on an input by the user of the terminal by the wireless communication section when supply of power to the processing section of the information processing apparatus is stopped; and
starting supplying power to the processing section in response to detection of the approach of the user of the terminal by the detection section after the authentication succeeds.

19. An information processing control system comprising:
a terminal; and
an information processing apparatus,
wherein the information processing apparatus comprises:
a wireless communication section that operates by receiving first power supplied;
a processing section that operates while being supplied with second power which is greater than the first power;
a detection section that detects approach of a user;
an authentication processing section that authenticates a user of a terminal in response to reception of a request from the terminal based on an input by the user of the terminal by the wireless communication section; and
a control section that starts supplying the second power to the processing section in response to detection of the approach of the user of the terminal by the detection section after the authentication succeeds.

20. An image processing method of an information processing apparatus, the information processing apparatus comprising a wireless communication section that operates while being continuously supplied with power, a processing section, and a detection section that detects approach of a user, the image processing method comprising:
authenticating a user of a terminal in response to reception of a request from the terminal based on an input by the user of the terminal by the wireless communication section when supply of power to the processing section of the information processing apparatus is stopped; and
starting supplying power to the processing section in response to detection of the approach of the user of the terminal by the detection section after the authentication succeeds.
